(19) United States
(12) Patent Application Publication
(10) Pub. No.: US 2008/0306852 A1
(43) Pub. Date: Dec. 11, 2008

(54) Home Registry with Advertiser Contributions

(76) Inventor: Donne Kerestic, Corona Hills, CA (US)

Correspondence Address: FISH & ASSOCIATES, PC;ROBERT D. FISH, 2603 Main Street, Suite 1050, Irvine, CA, 92614-6232, US

(21) Appl. No.: 12/133,476

(22) Filed: Jun. 5, 2008

Related U.S. Application Data
(60) Provisional application No. 60/942,179, filed on Jun. 5, 2007.

(51) Int. Cl. G06Q 40/00

(52) U.S. Cl. 705/35

(57) ABSTRACT

Systems and methods assist a potential home buyer in funding a down payment for a residence, by accumulating contributions towards the down payment at least in part as a first function of purchases made through a first business, and keeping track of the contributions. All suitable interfaces are contemplated including especially electronic web page interfaces. Contributions can include cash, but also other suitable types, including for example points, and discounts. The purchases used as a basis for making contributions can be made by the potential home buyer, or by other person or entity. In especially preferred embodiments, a commercial lender, relative, builder, a builder's agent, or other third party can match some or all of the contributions. At least one of the contributions can be returned to a donor if the down payment is not used to purchase the residence during a given period of time.

This application claims priority to U.S. provisional application No. 60/942,179 dated Jun. 5, 2007 which is incorporated by reference herein in its entirety.

### FIELD OF THE INVENTION

The field of the invention includes a gift registry services for engaged couples.

### BACKGROUND

Gift registry services have a long history in the United States. One fairly recent development is the use of the Internet to host registry services. On-line registries have many benefits, including allowing donors to contribute without having to be physically present in any particular store. Although many on-line registries showcase only a particular brand or otherwise limited products and services for engaged couples, on-line registries can provide essentially unlimited space for a wide variety of goods and services. It is known for on-line registries to offer discounts or other promotions from vendors, which can be changed readily on the web sites.

Another development is the use of bridal registries to receive money contributions instead of physical gifts. A 2001 CNN™ article (http://money.cnn.com/2001/04/25/living/q_bankrate/) touted the benefits of money contributions over physical goods. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

In some cases, the money contributions have been directed towards specific purposes. In one Internet gift registry site, for example, a couple is seeking donations for several charities, and is requesting matching contributions from corporations. See http://one-dream.org/GiftRegistry. In other instances gift registry money contributions are specifically requested for housing. In 1996, for example, the Federal Housing Administration began offering a housing registry to accumulate donations for use as a down payment on a home. Although there were originally about 20 major lenders in that field, most have since dropped out. A significant drawback of the FHA program is that down payment donations are limited to those received by family and friends. Under certain conditions, gifts are allowed if the donor is a an employer, or a humanitarian, welfare, or charitable organization, but in such cases a gift letter, signed by the donor, is required stating the amount given and specifying that no repayment is expected, (See HUD Handbook 4000.2 REV-2).

SunTrust Mortgage is a significant lender in the field, but their program still requires that gifts must be from friends and family that do not have a financial interest in the transaction and cannot be from participants (seller, builder, real estate agency, etc.) with a financial interest in a home purchase. See http://www.suntrustmortgage.com/bridalrg.asp.

US 2006/0129469 to Schmidlin (publ. Jun. 15, 2006), teaches a home registry that allows friends and family to contribute to an account that accumulates funds for a home down payment. Schmidlin goes even further in contemplating that third parties, including for example business that offer wedding services, could also contribute.

Interestingly, it appears that all of the prior art in this field contemplate contributors making their contributions as stand-alone transactions, without any direct correlation to purchases or sales. For example, Schmidlin contemplates businesses contributing to the home registry as a form of advertising, in the hope that the recipient can utilize their services. Thus, what are needed are registry systems and methods in which at least some of the contributions are received as a function of someone actually purchasing goods of services.

### SUMMARY OF THE INVENTION

The present invention provides apparatus, systems and methods in which a potential home buyer funds a down payment for a residence, by accumulating contributions towards the down payment at least in part as a first function of purchases made through a first business, and keeping track of the contributions.

All suitable interfaces are contemplated, including especially the method of claim 1 wherein at least one of the resources comprises an electronic web page interface.

All suitable types of contributions are also contemplated, including for example, contributions comprising cash, points, and discounts. The purchases used as a basis for making contributions can be made by the potential home buyer, or by other person or entity. In especially preferred embodiments, a commercial lender, relative, builder, a builder's agent, or other third party can match some or all of the contributions.

It is still further contemplated that at least one of the contributions can be returned to a donor if the down payment is not used to purchase the residence during a given period of time.

It is still further contemplated that a corresponding strategy can be used to fund transactions other than home buying, including for example wedding services, and purchase of big ticket items such as an automobile, a plane, a boat, or a vacation.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic showing use of a home registry system to accumulate contributions for a down payment to a home.

FIG. 2 is a flowchart of a preferred method, along with various preferred options.

### DETAILED DESCRIPTION

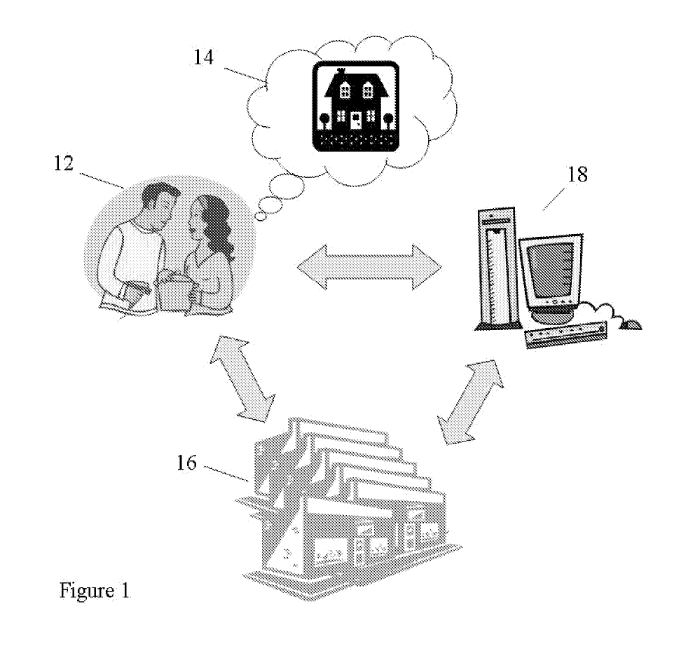

In FIG. 1, a prospective home buyer 12 contemplates purchasing a home 14. The home buyer opens an account with a registry service 18, and either the home buyer or others make purchases at one more businesses shown here collectively with numeral 16. As a function of such purchases, the business(es) 16 make contributions to the account on behalf of the home buyer 12.

Those skilled in the art will appreciate that home buyer 12 is depicted here euphemistically, and can include any one or more persons or any age(s), gender(s), and so forth. Similarly, it should be appreciated that the term “home” is used here in its broadest possible sense to include any residence for which rights can be purchased, including for example, houses, condominiums, time shares, and even long leaseholds. As used herein the term “down payment” refers to any payment that is less than the purchase price of all of the ownership rights in the residence.

The registry service 18 is schematically depicted as a single computer, but those in the art will appreciate that any suitable computer, computer system, network, and so forth can be used. In the currently computing environment, connections to the registry service 18 would be made via the Internet, but of course all other suitable connections are contemplated, including for example successors to the current Internet.

Similarly, all suitable businesses are contemplated, including for example photographers, caterers and others that might regularly deal with weddings, but also painters and construction works that might deal regularly with remodeling, and even car dealerships and others that might have nothing whatsoever to do with wedding or even homes.

A preferred method can also match the needs of the potential home buyer or other person or entity with the products or services offered by the businesses. For example, in preferred embodiments a bride or other registrant can go to a registry website and select the types of products or services they are interested in (such as a residence, photographers, travel services, catering, painters, etc.). The registry would then match the bride's preferences to vendors offering those goods or services.

It is further contemplated that a potential home buyer can specify requirements such as location, price, square footage, move-in date, community amenities, and other such search criteria to the registry. In preferred embodiments, the registry will match the potential home buyer's requirements to the businesses' supply and provide the potential home buyer with a listing of buyers whose supply meets the specified requirements.

In other embodiments the potential home buyer or other entity can search for a home or other product or service based on their matching rewards. For example, a potential home buyer could search for a home that has a rewards match of 100%,. 150% or 200%.

The term “contributions” should also be interpreted herein in its broadest possible sense. Thus, contributions can include physical cash, demand deposits, certificates of deposit (CDs), and also such things as points and discounts.

In one aspect of preferred embodiments, a web site offers a registry service for an engaged couples or other prospective home buyers. In the case of an engaged couple, one or more of the wedding guests, friends, and family members and possibly others would contribute money to the engaged couple. A record of the funds received would typically be recorded in an account maintained by the registry services for that purpose, although the actual funds would likely be kept in a bank account. That account would most likely be in the name of the registry service, with the funds being released during the escrow process or at some other time designated by the registry, potential home buyer, bank, or other person or entity. The registry service might allow interest to accrue to the benefit of the prospective home buyers, but could also accrue the interest to itself. Independently of interest accumulation, the registry service might also charge a processing fee.

In particularly preferred embodiments, a registry system targets as contributors, new home builders, real estate agencies, mortgage lenders, and companies that offer products and services to newlyweds. Such a system should also allow the entities to pay a brokering fee for advertising. By having direct access to the consumer, entities have several advantages: elimination of the middle man between the entities; entities that wish to advertise will extend their advertising dollar because they can target their message more appropriately; and the newlyweds could have the ability to choose how their money will be used.

It is especially contemplated that the registry can be coupled with a referral service. This is especially important in home buying and wedding related activities because those activities are generally infrequent in the life of many individuals. Referrals can be made on any suitable basis, but most preferably on a rotating basis so that the business is spread out among multiple vendors for similar services.

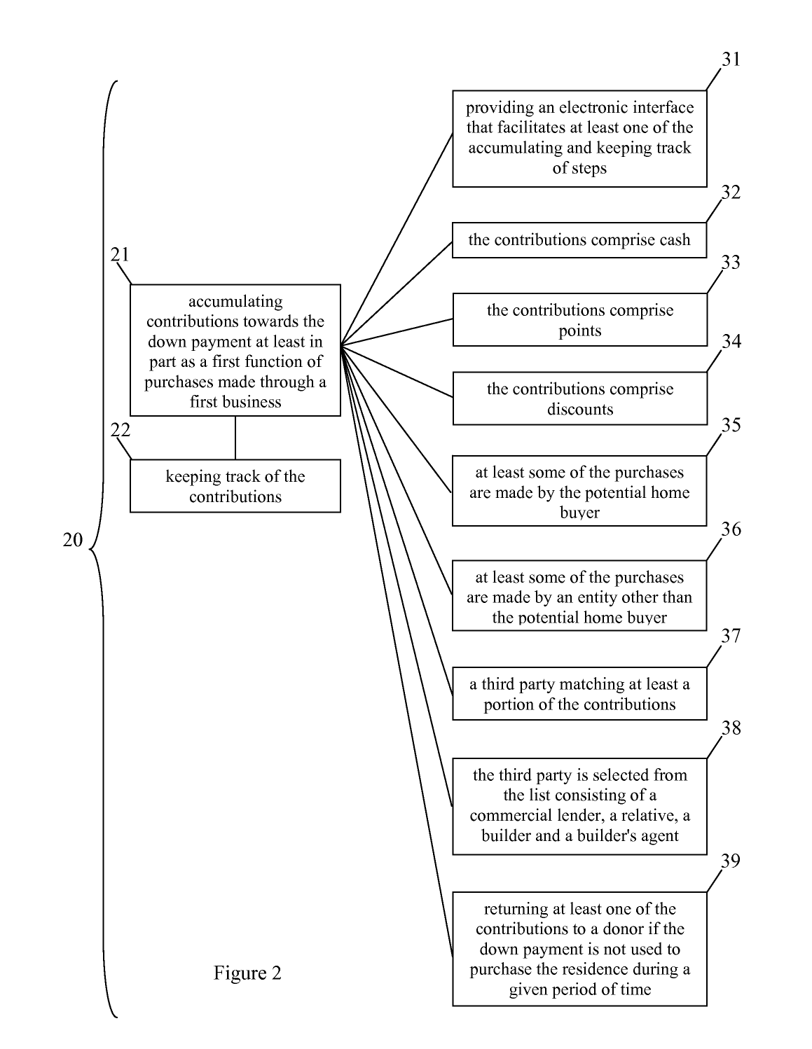

In FIG. 2, a method of operating a home registry 20 generally includes step 21, accumulating contributions towards the down payment on a residence as a function of purchases made through a business, and step 22, keeping track of the contributions.

Step 21 can be accomplished in any suitable way, including for example, option 31, providing an electronic interface that facilitates the accumulating and keeping track of contributions. Those skilled in the art will appreciate that an electronic interface can be implemented on a CRT, flat screen, PDA, cell phone or any other suitable display device, using any suitable computer, computer system, or network.

Contributions can include cash, but all other suitable types of contributions are also contemplated, including for example points, and discounts (options 31 through 33). Cash contributions are considered especially advantageous because they can be directly deposited to a bank account, by any entity. Points are also considered advantageous because they allow a business to contribute a finite amount without actually contributing cash. In some preferred embodiments, points can advantageously be converted into cash at a later date, or into some other asset such as discounts. Contributing discounts appears to be completely novel in the industry, and is again a way for businesses to make contingent contributions instead of cash.

In any or all of these situations, the contributions could be restricted functionally, temporally or in some manner. For example, cash could be functionally restricted for use on a down payment, or for a home improvement (possibly as opposed to jewelry or a stereo system). Cash could also be temporally restricted for use within a 6 month period. In other examples, discounts at a furniture store could be functionally restricted for use on certain types of furniture (such as bedroom or living room sets), or at particular store locations.

It is contemplated that any suitable method of collection can be used to process contributions received from donors. For example, a registry could electronically collect cash contributions from vendors and place the funds in an account for the potential home buyer.

Purchases can be made by the potential home buyer(s) as shown in option 35, or by a friend, relative, business associate, or any other entity as shown in option 36. Such other entities might or might not have an interest in the transaction (the purchase of the residence).

As option 37 shows, a third party can match at least a portion of the contributions. It is especially contemplated that homebuilders and companies that offer new home related products and services would match some percentage (e.g., 50%, 100%, 150%, 200% etc) of the amount contributed in the member's account. Matching could also relate to geographic location. A builder might, for example, offer 100% matching in their Irvine, Calif. development, but a 200% match in nearby Corona. Matching contributions could be unrestricted, but more likely would be restricted for specific uses, such as a down payment for a home, escrow services, and so forth.

As depicted in option 38, the third party can be selected from a list consisting of a commercial lender, a relative, a builder, and a builder's agent. Those having a financial interest in a housing or other transaction might also be contributors. It is appreciated that such a provision might well exclude HUD and/or other government agencies from sponsoring or supporting a program that satisfies this limitation.

Step 39 contemplates returning one or more of the contributions to a donor if the down payment is not used to purchase the residence during a given period of time. In practice, a donor could set a time period (e.g. 15 days, 6 weeks, 5 months, 2 years, etc.) during which the down payment must be used to purchase the residence. If at the end of the specified period the down payment has not been used, the full amount or a portion of the donor's contribution. The same concept can be applied to unused discounts or points, or possibly other types of contributions. In yet other embodiments, cash or other types of contributions could be transferred out of the registry. For example, cash could be transferred (or converted) to a standard savings account at a bank. Cash or other types of contributions could be transferred to the benefit of another home buyer, and so forth.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of funding a down payment for a residence, comprising the steps of:
accumulating contributions towards the down payment at least in part as a first function of purchases made through a first business; and
keeping track of the contributions.

2. The method of claim 1 further comprising providing an electronic interface that facilitates at least one of the accumulating and keeping track of steps.

3. The method of claim 1 wherein the contributions comprise cash.

4. The method of claim 1 wherein the contributions comprise points.

5. The method of claim 1 wherein the contributions comprise discounts.

6. The method of claim 1 wherein at least some of the purchases are made by the potential home buyer.

7. The method of claim 1 wherein at least some of the purchases are made by an entity other than the potential home buyer.

8. The method of claim 1 further comprising a third party matching at least a portion of the contributions.

9. The method of claim 1 wherein the third party is selected from the list consisting of a commercial lender, a relative, a builder and a builder's agent.

10. The method of claim 1, further returning at least one of the contributions to a donor if the down payment is not used to purchase the residence during a given period of time.
